(19) United States
(12) Patent Application Publication
(10) Pub. No.: US 2026/0298216 A1
(43) Pub. Date: Oct. 1, 2026

(54) METHOD OF OPTIMIZING A COIL PUMP SYSTEM

(71) Applicant: MMC First Process AS, Fosnavåg (NO)

(72) Inventor: Eivind VINJE, Ålesund (NO)

(21) Appl. No.: 19/476,856

(22) PCT Filed: Apr. 19, 2024
(86) PCT No.: PCT/NO2024/050094

§ 371 Date: Oct. 21, 2025

(30) Foreign Application Priority Data
Apr. 21, 2023 (NO) 20230436

(51) Int. Cl. F04B 19/12; A01K 79/00; F04B 49/06; F04B 49/22

(52) U.S. Cl. CPC F04B 19/12; A01K 79/00; F04B 49/065; F04B 49/22

(57) ABSTRACT

A method for improved functioning of a coil pump system, comprising configuring an inlet air valve, wherein configuring the air valve comprises: a) identifying a particular air valve of the coil pump system out of a predetermined number of potential air valves; b) providing a pump speed for a coil pump in the coil pump system; c) providing a suction height of the coil pump system; and d) retrieving an amount of opening of the identified air valve of the coil pump system for the associated provided pump speed and suction height to achieve a desired flowrate through the coil pump system wherein step d) further comprises: using at least one valve opening relationship matrix for a specific flow rate and at a selected predetermined air-water ratio in a predetermined loop of the coil pump; wherein said at least one valve opening relationship matrix comprises a series of valve openings against corresponding pump speeds and suction heights; and retrieving from said valve opening relationship matrix a valve opening corresponding to the provided pump speed and suction height at the desired flowrate and air-water ratio.

### BACKGROUND

A coil pump is a type of positive displacement pump that moves fluid through a helical coil using a manometric effect. The pump consists of a helical coil that is driven by a motor or other external means, such as a hand crank.

As the helical coil rotates, it takes in a plug of liquid and a plug of air through the inlet of the coil. The position of the air and liquid plugs along the axis of the coil varies as the coil rotates, with the position of the plugs changing throughout the cycle.

As each pair of plugs moves through the helical coil, it acts as a manometer, sustaining a pressure difference across the pair. The action of multiple pairs of liquid and air plugs constitutes a cascading manometer, where the head difference across the pump increases as the individual liquid level differences increase to balance the total pressure difference across the pump.

The liquid level differences in the coils are governed by the rotation of the liquid plugs relative to the external liquid level, which is controlled by the compression of the air plugs. As the head difference across the pump increases, the individual liquid level differences have to increase to balance the total pressure difference across the pump.

Overall, the coil pump provides a reliable and efficient means of transporting fluid by utilizing the manometric effect and positive displacement action. The design of the helical coil and use of air and liquid plugs result in a pump that is capable of sustaining high pressure differences while maintaining a consistent flowrate. Furthermore, the design does not require the use of impellers, making it suitable for gentle pumping of objects/organisms.

However, current coil pump designs have limitations between their flowrate and lifting height. The nonlinear complexity of the air valve pressure drop makes overcoming these limitations challenging. Thus, it is an object of this invention to address the current limitations between coil pump functionality with respect to flowrate and lifting height capabilities.

### SUMMARY OF THE INVENTION

According to a first aspect of the invention there is provided a method for improved functioning of a coil pump system, comprising configuring an inlet air valve, wherein configuring the air valve comprises: a) identifying a particular air valve of the coil pump system out of a predetermined number of potential air valves; b) providing a pump speed for a coil pump in the coil pump system; c) providing a suction height of the coil pump system; and d) retrieving an amount of opening of the identified air valve of the coil pump system for the associated provided pump speed and suction height to achieve a desired flowrate through the coil pump system wherein step d) further comprises: using at least one valve opening relationship matrix for a specific flow rate and at a selected predetermined air-water ratio in a predetermined loop of the coil pump; wherein said at least one valve opening relationship matrix comprises a series of valve openings against corresponding pump speeds and suction heights; and retrieving from said valve opening relationship matrix a valve opening corresponding to the provided pump speed and suction height at the desired flowrate and air-water ratio.

The at least one relationship matrix for the specific flowrate and at least one air-water ratio may be computationally generated in real time.

Using the at least one valve opening relationship matrix may comprise: accessing a series of pre-calculated databases of valve openings against corresponding pump speeds and suction heights for a series of flowrates and at least one air-water ratio stored in accessible computer memory; and selecting a specific valve opening database for the specific flow rate and at a selected predetermined air-water ratio out of the series of pre-calculated databases; and using the selected valve opening database to retrieve a valve opening corresponding to the provided pump speed and suction height at the desired flowrate and air-water ratio.

Step c) may comprise measuring the suction height of the coil pump by an inlet pressure sensor at an inlet end of the coil pump.

Step c) may comprise manually inputting the suction height.

The method may further comprise a verification step comprising: running the coil pump at a selection of predetermined pump speeds, air-water ratio and suction heights; adjusting a valve opening whilst measuring a resulting flowrate; and comparing said measured resulting flowrates at the selected pump speeds, air-water ratio and suction heights to corresponding flowrates provided in a valve opening database.

The predetermined air-water ratio in a predetermined loop of the coil pump is 1:1.

The method may further comprise extending a functioning capability of the coil pump system such that a greater range of pump speed, flowrate and pumping height combinations become available by deviating the air-water ratio in the predetermined loop of the coil pump away from a 1:1 ratio to achieve a particular functioning of the coil pump.

The valve opening relationship matrix may have a further parameter dependency, said parameter dependency being a plurality of air-water ratios.

The series of available valve opening databases for a plurality of flowrates and at least one air-water ratio, may comprise a series of valve opening databases for a plurality of flowrates and a plurality of air-water ratios.

The plurality of air-water ratios may range from 3:7 to 7:3.

The particular functioning of the coil pump system may comprise: an increased pumping height of the coil pump system; or an increased flowrate at a constant pump speed.

Within certain predetermined parameters, the flowrate, pump speed, pumping height, and air-water ratio may be configured to achieve a maximum energy efficiency.

The method may further comprise compensating for unintentional air in the coil pump system by: identifying a change in pressure by the inlet pressure sensor when the pump is operating at a constant pump speed and with a static suction height on an inlet side of the coil pump; and/or identifying a change in pressure by an outlet pressure sensor when the pump is operating at a constant pump speed and a static lifting height on an outlet side of the coil pump, wherein a reduced pressure indicates the presence of unintentional air; and adjusting the inlet air valve opening to reduce air intake through the valve to compensate for the presence of unintentional air.

According to another aspect of the invention there is provided a coil pump system comprising: a coil pump comprising: a tubular rotor with a helical channel with at least two windings; an intake end comprising: an inlet valve, said valve comprising an inlet control module; and an inlet pressure sensor; and an outlet end comprising: an outlet pressure sensor; and an outlet air valve; and a program module, the program module in data communication with the inlet control module, the inlet pressure sensor, and the outlet pressure sensor; wherein the system is configured to adjust an opening of the inlet air valve, by accessing a relationship matrix of flowrate, air-water ratio and suction height, to achieve a predetermined flowrate.

The coil pump system may further comprise a noise cancelling unit comprising: a pipe fluidly connected at a first end to the inlet air valve, at a second end to the outlet air valve; said pipe configured to redirect air released through the outlet air valve into the coil pump inlet via the inlet air valve.

The pipe may have a diameter at least two times the diameter of the air inlet valve and at most 5 times the diameter of the air inlet valve.

The program module may comprise computer readable instructions that, when executed on a processor, perform the method of the first aspect.

The coil pump system may further comprise: an inlet pipe connected at a first end to the intake end of the coil pump; an outlet pipe connected at a first end to the outlet end of the coil pump; a container for fish connected to a second end of the inlet pipe; and a grading unit, dewatering unit, or container connected to a second end of the outlet pipe; wherein, in use, the system is configured such that a liquid level in the container for fish is below a centre height of the coil pump.

The inlet pressure sensor may be further configured to measure a change in pressure at the inlet end when the coil pump is running at a constant pump speed and at a static suction height; and/or the outlet pressure sensor may be further configured to measure a change in pressure at the outlet end when the coil pump is running at a constant pump speed and at a static lifting height; to identify the presence of unintentional air.

The coil pump system may further comprise a fish counter, said fish counter located at the inlet pipe, at the outlet pipe or at an outlet of the grading unit, the fish counter in communication with the program module and configured to provide feedback modify the flowrate such that fish traveling through the pump system are crowded within a predetermined density range.

The coil pump system may be configured to carry out the method of the first aspect.

According to a yet further aspect of the invention there is provided a computer readable medium with instructions that, when executed on a processor, perform the steps of the first aspect of the invention.

The coil pump system may have the program module comprising the computer readable medium.

### BRIEF DESCRIPTION OF THE DRAWINGS

FIG. 1a is a schematic diagram of a known coil pump;

FIG. 1b is a schematic diagram of a coil pump system showing dimensions;

FIG. 2 is an illustrative diagram of a coil pump represented in two-dimensions;

FIG. 3 is an illustrative diagram of a loop of the coil pump;

FIG. 4a is a systematic diagram of an example valve for use in a coil pump;

FIG. 4b shows a graph of airflow through a valve against percentage opening for three types of coil pump valve;

FIG. 5a is a perspective view of a coil pump according to the invention;

FIG. 5b is a schematic diagram of a coil pump system according to the invention;

FIG. 6 is a flowchart of a method of improved functioning of a coil pump according to a first example;

FIG. 7 is a flowchart of an example method of creating flowrate and air-water ration dependent databases of valve opening against pump speed and suction height;

FIG. 8 shows a graph of maximum flowrate against maximum total pumping height of an example coil pump system according to the invention;

FIG. 9 show a coil pump system according to an example of the invention;

FIG. 10 show a coil pump system according to another example of the invention;

FIG. 11 shows an example arrangement of a coil pump system according to the invention;

FIG. 12 shows another example arrangement of a coil pump system, according to the invention, comprising a centrifugal pump; and

FIG. 13 shows a noise cancelling unit arranged on the coil pump of FIG. 5a.

### DEFINITIONS

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art.

The term ‘pump speed’ is used in this text to describe a rotational speed of the pump. Pump speed values are given in revolutions per minute (rpm).

The term ‘flowrate’ is used in this text to describe an amount of fluid that passes through the pump per unit of time primarily given herein in units of cubic meters per hour. Unless specified otherwise, flowrate refers to a liquid flowrate in the pipe at the inlet side of the pump per unit of time.

The term ‘air-water ratio’ is used in this text to describe a ratio of air to water that is present in the pump and, unless specified otherwise, refers to the air-water ratio in the first loop of the coil pump.

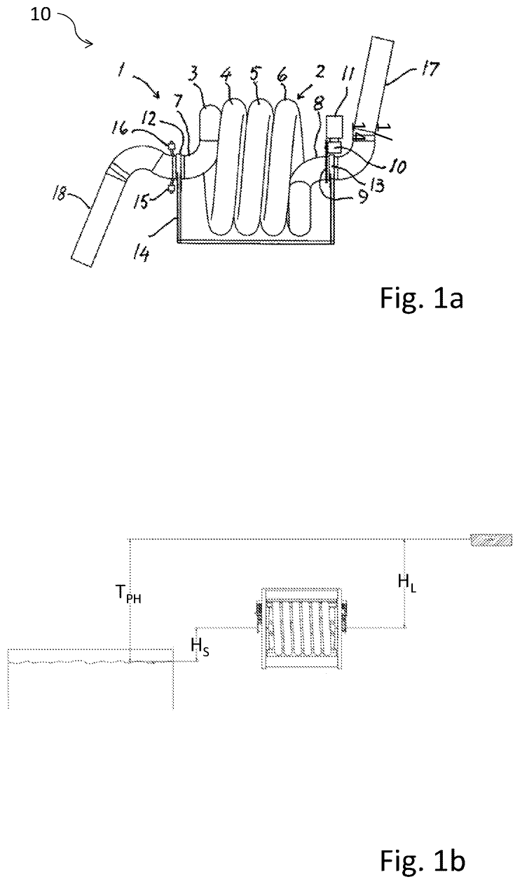

The term ‘static lifting height’ is used in this text to describe a vertical height difference between a coil pump outlet and a fixed discharge point, such as the top of a grading unit in a coil pump system. With regards to FIG. 1b, the lifting height is the distance labelled HL.

The term ‘lifting height’ is used in this text to describe the static lifting height plus a pipe resistance between the outlet of the pump and the discharge point.

The term ‘static suction height’ is used in this text to describe a vertical distance from the surface of the liquid source, such as a reservoir or tank, to an inlet of the coil pump. With regards to FIG. 1b, the suction height is the distance labelled Hs.

The term ‘suction height’ is used in this text to describe the static suction height plus a pipe resistance between the surface of the liquid source and the inlet of the coil pump.

The term ‘total pumping height’ is used in this text to describe the total vertical distance that the fluid needs to be moved by the pump, i.e., the static suction height plus the static lifting height. With regards to FIG. 1b, the total static pumping height is the distance labelled TPH.

The term ‘capacity’ is used in this text to describe a lifting height potential of a coil pump given its flowrate.

The term ‘head loss’ is used to describe a total pressure loss as measured by the pump, including the total pumping height from a suction point to a discharge point, and the friction from the pipe system, i.e., the suction height plus the lifting height. Head loss is dependent on flowrate.

### DETAILED DESCRIPTION

FIG. 1 is a schematic diagram of a known coil pump 10. Coil pump 10 has a helical rotor 2 with four windings (loops) 3, 4, 5, 6. The tube rotor 2 may be formed from a plastic tube which is hot-formed about a cylindrical core (not shown) so that it has an axial intake end 7 and an axial outlet 8. At the outlet end 8 in the example, a drive wheel 9 is attached as if with an appropriate drive connection 10 with a motor 11. The drive connection 10 can be a drive belt, a drive chain or a drive shaft with gears. At the intake end 7 and at the outlet end 8, a rotating coupling 12, 13 respectively, is placed which is in a bearing bracket 14. Connected to the rotary coupling 12 at the intake end 7 is a water valve 15 connected to a water supply (not shown) and an air valve 16 connected to an air pump (not shown). The water valve 15 can be operated manually or controlled automatically, while the air valve 16 is preferably automatically controlled with an appropriate management system. As an alternative to air, the valve 16 can let in a gas which is designed for pumping special mass. The pump in the example has an intake pipe or hose 18 designed to be lowered into the mass to be pumped. The mass to be pumped is typically a liquid containing live fish wherein the liquid is water.

Throughout the remainder of this text the gas in the coil pump system is referred to as ‘air’ and the liquid in the coil pump system is referred to as ‘water’. Air is the preferred gas and water is the preferred liquid, however alternatives are possible and considered included within the scope of the below described invention.

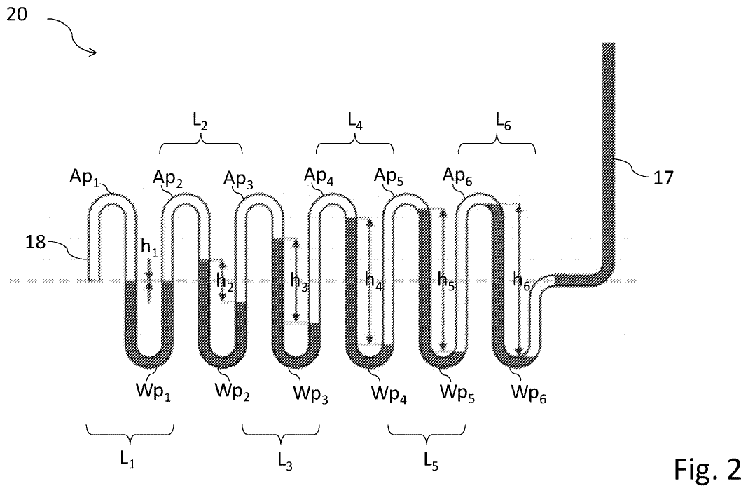

FIG. 2 is an illustrative diagram of a coil pump 20 represented in two-dimensions. Coil pump 20 is substantially similar to coil pump 10, however coil pump 20 has six loops L1 to L6. Each loop Ln has an air plug Apₙ and a corresponding water plug Wpₙ. Thus, the loop L₁ has an air plug Ap₁ and a water plug Wp₁, the loop L₂ has an air plug Ap₂ and a water plug Wp₂, the loop L₃ has an air plug Ap₃ and a water plug Wp₃, loop L₄ has an air plug Ap₄ and a water plug Wp₄, the loop L₅ has an air plug Ap₅ and a water plug Wp₅, and loop Le has an air plug Ap₆ and a water plug Wp₆. A liquid level difference is a height difference between a leading edge of a water plug and its trailing edge. Loop L₁ has a liquid level difference h₁. Loop L₂ has a liquid level difference h₂. Loop L₃ has a liquid level difference h₃. Loop L₄ has a liquid level difference h₄. Loop L₅ has a liquid level difference h₅. Loop Le has a liquid level difference h₆. As shown in FIG. 2, the liquid level difference increases from an inlet end 18 to an outlet end 17 of the coil pump 20. The action of multiple pairs of water plugs and air plugs constitutes a cascading manometer, where a head difference across the pump increases as the individual liquid level differences increase to balance a total pressure difference across the pump.

In the first loop L₁, the coil pump 20 has an initial composition of 50% air and 50% water, which gives a desirable 1:1 ratio. As the pump 20 operates, the air becomes more and more compressed, resulting in a reduction in the volume of air present in the pump. The final composition of the pump will still be 50% water, but the air content may have reduced to around 40%. This compression of air causes the water plug to shift upwards along the side of the pump, enabling the pump 20 to lift water and withstand pressure from the lift.

A number of parameters effect the working of the coil pump 20. These parameters include: drum diameter, pipe diameter, depth of drum immersion pressure at pump outlet, speed of drum rotation (pump speed), total number of loops LN, inlet pressure (normally assumed to be atmospheric).

In a coil pump, the pump speed, flowrate, air-water ratio, and head loss are interconnected and influence each other in the functioning of the pump. The flowrate is influenced by the pump speed and the air-water ratio. The ratio of air to water can be adjusted to control capacity; the flowrate and maximum head loss potential. Overall, the pump speed, flowrate, air-water ratio, and head loss are interconnected and need to be considered together when designing and operating a coil pump. Adjusting one variable can impact the performance of the other variables, and finding the right balance between them is crucial for achieving optimal pump performance.

The main effect of pump speed is on the flowrate. Pump speed may also indirectly affect the level differences in the loops since a higher pump speed increases head loss (pipe resistance due to increased flowrate).

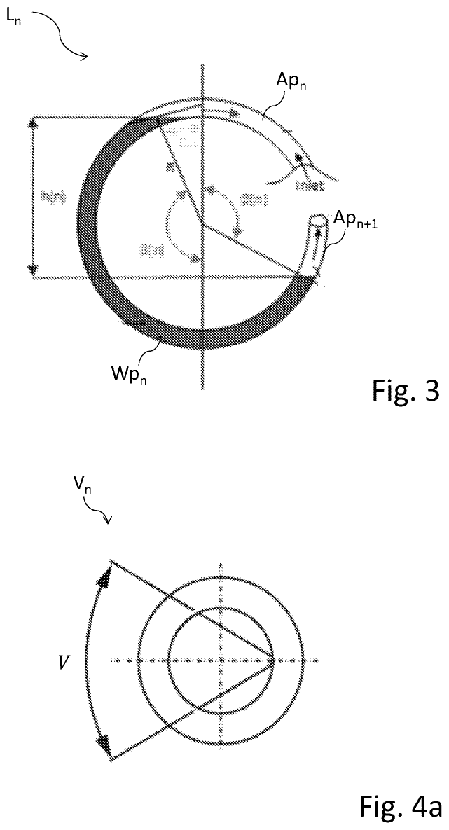

FIG. 3 is an illustrative diagram of a loop Ln of a coil pump such as coil pump 10 or 20. As mentioned above, the loops contain a water plug Wpₙ and an air plug Apₙ. Each water plug Wpₙ in the coil pump has a water plug length and each air plug Apₙ has an air plug length. Above certain upper and lower boundaries of air plug/water plug lengths, two phenomena can occur: spilling and bubbling. As a liquid plug progresses through a coil, it rotates relative to the external liquid surface as already mentioned. As this rotation is sufficiently great so that the trailing edge of the liquid plug reaches the crown of the pipe, then spilling occurs when the liquid spills over the crown of the loop as will be explain further below. Bubbling occurs if air passes through a water plug through a bottom side of a corresponding loop due to too little water in the plug.

Gross bubbling can occur with an air plug length of less than 20% of an effective pipe drum circumference, making the pump virtually inoperable. With an air plug length of 80%, gross spilling may occur, producing a similar effect. These two values provide an initial guide for the range of acceptable air plug lengths.

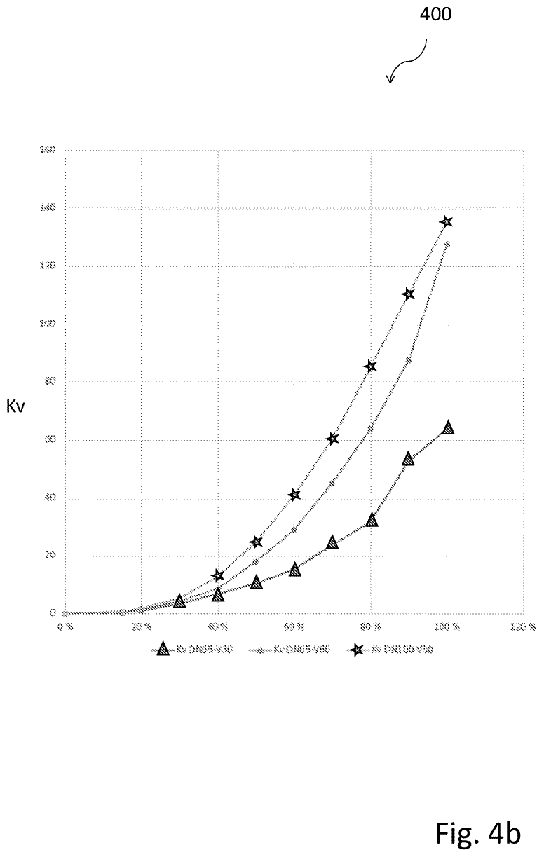

FIG. 4a is a schematic diagram of an example valve Vn for use in a coil pump. Valve Vn is a V-port ball valve and is a type of control valve that uses a ball (not shown) with a V-shaped notch to regulate a flow of air through said valve. The ball is rotated by a stem (not shown) that extends from a top of the valve and is operated either manually or by an actuator. The V-shaped notch in the ball allows for precise control of an air flow, as the opening can be adjusted to match the required flowrate. The V-port ball valve is particularly useful in this application since it can be easily adjusted and provides accurate control. V is the angle in degrees of the V-shaped notch. In the example of FIG. 4a, V is equal to 60 degrees. The valve is also durable and long-lasting, with a low maintenance requirement. Overall, the V-port ball valve Vn is a versatile and effective control valve that provides precise control over air flowrates and is well-suited to use in the coil pump system of the invention. However, the V-port ball valve is a non-limiting example. Other valve types, such as a diaphragm valve, a ball valve, a gate valve, may be equally suitable for implementing in the system according to the invention.

FIG. 4b shows a graph 400 of a typical curve for different valves suitable for the coil pump according to the invention. The graph shows a relationship between a percentage opening against Kv for three different types of valves suitable for implementing into the coil pump system of the invention, wherein Kv is a measure of airflow per unit time. The three valves are a first DN65 valves with a V of 30 degrees, a second DN65 valve with a V of 60 degrees, and a DN100 valve with a V of 30 degrees.

The comparisons between suitable valves for the coil pump system as demonstrated by the graph can be considered to choose the best valve for the pump system depending on predetermined requirements.

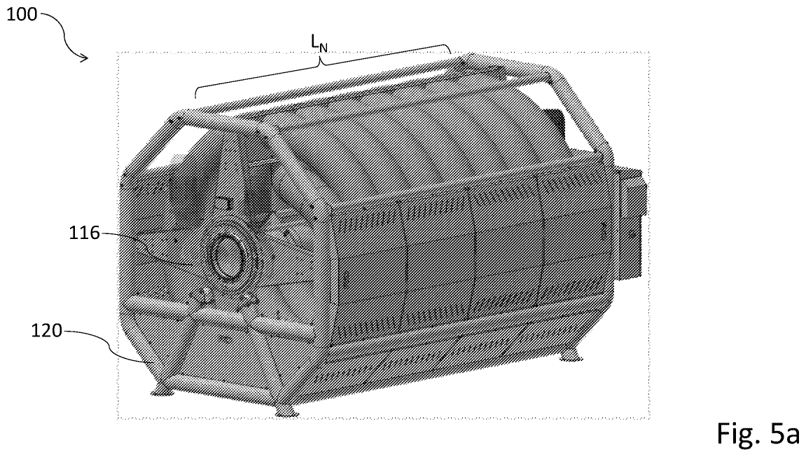

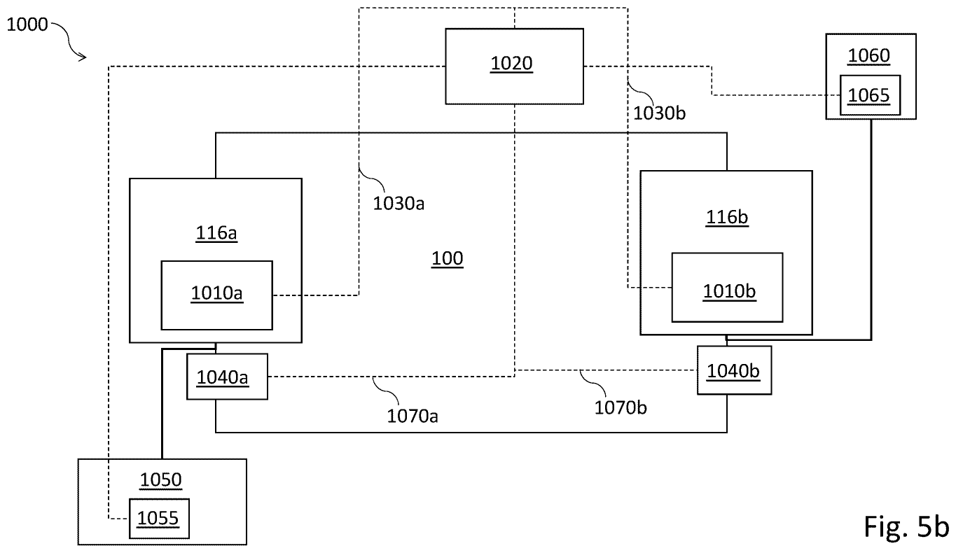

FIG. 5a is a perspective view of a coil pump 100 according to the invention. The coil pump 100 is substantially similar to the coil pump 10 as shown in FIG. 1 and has a number of loops L_{N}. In the example of FIG. 5a the coil pump 100 has 7 loops. Coil pump 100 works on the same principles as described above in order to gently pump water upwards against gravity. Coil pump 100 further comprises an inlet air valve 116 with a control module (not shown) to configure an opening of the air valve 116 for adjusting an airflow through coil pump. The inlet air valve control module is in data communication with a program module (not shown) which comprises software to compute a correct opening of the inlet air valve 116 to achieve the desired airflow through the coil pump 100. The air valve 116 maybe one of the valves in the graph of FIG. 4b. Coil pump 100 further comprises a stability frame 120 which stabilizes the coil pump against the rotation of the stator.

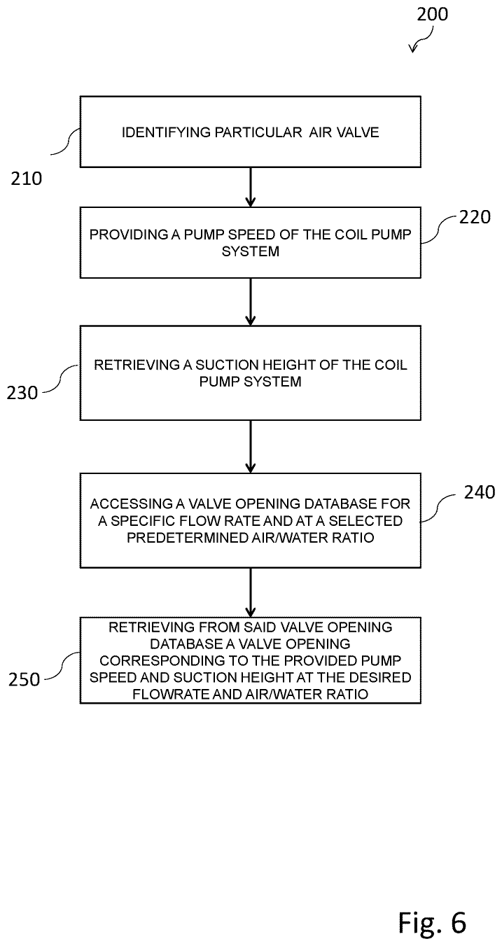

FIG. 5b is a schematic diagram of a coil pump system 1000 comprising the coil pump 100, a container for fish 1050, a grading unit 1060, and a program module 1020. The coil pump 100 has an inlet air valve 116a with a corresponding control module 1010a, an outlet air valve 116b with a corresponding control module 1010b, an inlet pressure sensor 1040a and an outlet pressure sensor 1040b. The air outlet valve is used to remove air at the outlet end of the pump to avoid air added at the inlet going to the outlet pipe. As demonstrated by dotted lines 1030a, 1030b, the control modules 1010a, 1010b are in data communication with the program module 1020. As demonstrated by dotted lines 1070a, 1070b, the pressure sensors 1040a, 1040b are also in data communication with the program module 1020. Preferably the control modules are integrated into their respective valve hardware 116a, 116b. Preferably the program module 1020 is wirelessly connected to the control module 1010 and the pressure sensor 1040. The container for fish 1050 may comprise sensors 1055. These sensors may be configured to detect a water level in said container. The grading unit may also contain sensors 1065. These sensors may be configured to determine a water level in said grading unit. The program module 1020 may be further in communication with the sensors 1055, 1065 of the container 1050 and grading unit 1060 respectively, in order to collect information from these parts of the coil pump system 1000 and integrate this into the method of controlling said coil pump system. A method executed by the program module 1020 to compute a correct air valve opening is described further with reference to FIGS. 6a and 6b.

FIG. 6a is a flowchart of a method 200 of improved functioning of a coil pump system such as the coil pump system of FIG. 5b. The method can be executed by the program module 1020 in data communication with the control module 1010a of the inlet air valve 166a of the coil pump 100. The method starts at 210 wherein a particular air valve to be configured is identified from a range of known air valves. At 220, a pump speed is retrieved and is the particular speed the pump is operating at. At step 230, a suction height of the coil pump system is provided and is the height difference between a water level of the water source (i.e., in the container) and a central height of the pump. The suction height is provided by measuring a pressure difference at the inlet pressure sensor and calculating the corresponding suction height. If the pressure sensor fails, the static suction height can be manually entered. Depending on a required accuracy, pipe system characteristics can also be entered manually to estimate the suction height, i.e., static suction height and pipe resistance. At step 240, a valve opening relationship matrix for a specific flowrate and at a selected predetermined air-water ratio is used. The valve opening relationship matrix comprises a list of valve openings against corresponding pump speeds and suction heights. At step 250, a valve opening corresponding to the retrieved pump speed and measured suction height at the desired flowrate and air-water ratio is retrieved from the determined valve opening relationship matrix.

In a first example, using the valve opening relationship matrix comprises accessing a series of pre-calculated databases of valve openings against corresponding pump speeds and suction heights for a series of flowrates and at least one air-water ratio stored in accessible computer memory; and selecting a specific valve opening database for the specific flow rate and at a selected predetermined air-water ratio out of the series of pre-calculated databases; and using the selected valve opening database to retrieve a valve opening corresponding to the provided pump speed and suction height at the desired flowrate and air-water ratio.

An example valve opening database is shown below:

TABLE 1
valve opening (in percentage) for corresponding pump speeds
and suction heights for a particular flow rate.

| | 1 m | 1.5 m | 2 m | 2.5 m |
|---|---|---|---|---|
| | suction | suction | suction | suction |
| Pump speed | height | height | height | height |
| 5 rpm | 56% | 53% | 52% | 49% |
| 9 rpm | 68% | 64% | 62% | 61% |
| 12 rpm | 76% | 71% | 67% | 66% |
| 14 rpm | 82% | 77% | 74% | 72% |
| 16 rpm | 89% | 82% | 79% | 76% |

The particular example valve database is specific to a RID 500 coil pump and is calculated based on an air-water ratio of 1:1 and an accepted spilling number of 3 loops. The valves given are illustrative only.

The valve opening database illustrated by table 1 is generated by first generating a table of valve openings versus suction heights which lists how much air will pass through the valve each hour. An example of this first preliminary database is shown below. The values given are illustrative only and provide examples of valve openings for a few different settings and a few different suction heights.

TABLE 2
How much air will pass through the valve each hour for
different valve openings versus suction heights.

| | 1 m | 1.5 m | 2 m | 2.5 m |
|---|---|---|---|---|
| | suction | suction | suction | suction |
| Valve opening | height | height | height | height |
| 20% | 15 m³/h | 17 m³/h | 19 m³/h | 20 m³/h |
| 40% | 108 m³/h | 128 m³/h | 143 m³/h | 153 m³/h |
| 60% | 347 m³/h | 410 m³/h | 456 m³/h | 490 m³/h |
| 80% | 723 m³/h | 854 m³/h | 950 m³/h | 1022 m³/h |
| 100% | 1150 m³/h | 1358 m³/h | 1511 m³/h | 1626 m³/h |

From the illustrative table, it is shown that, opening the valve to 20%, for a suction height of 1 m, provides around 15 m³/h of air passing through the valve. In contrast, opening the valve to 100%, for the same suction height of 1 m, provides around 1150 m³/h of air passing through the valve. This example demonstrates the exponential behaviour of the valves. This gives rise to the challenges in the complexity of configuring a coil pump system such as coil pump system 1000. As table 2 demonstrates, increasing the suction height increases the volume of air being drawn in through the same opening of the valve. Since table 2 is illustrative, it does not show the full range of suction heights that the method and system of the invention will use. In use, suction height will range for around 0.2 m to 8 m. Similarly, in use, the database used by the method/system of the invention will preferably have smaller intervals between valve openings, for example values for every 5% change in opening, preferably values for every 1% change in opening.

A second preliminary database is then generated which lists how much air we need from atmospheric pressure to get correct volume inside the pump for various pump speeds and suction heights. In other words, the second preliminary database provides a value for how much air is needed in the first loop of the coil pump for various pump speeds and suction heights. An example second preliminary database is shown below (table 3). The valves given are illustrative only. In the example provided, it is the first loop which is used in which a air-water ratio is measured and controlled, however another of the loops of the coil in the coil pump could be used in place of the first loop. For example, the third loop of the coil may be the loop in which a particular air-water ratio is specified to carry out the invention herein. The first loop in the coil is preferred for simplicity.

TABLE 3
Amount of air in cubic meters per hour required in a first loop
of the coil pump for different pump speeds and suction heights.

| | 1 m | 1.5 m | 2 m | 2.5 m |
|---|---|---|---|---|
| | suction | suction | suction | suction |
| Pump speed | height | height | height | height |
| 5 rpm | 262 m³/h | 252 m³/h | 243 m³/h | 227 m³/h |
| 9 rpm | 459 m³/h | 442 m³/h | 426 m³/h | 397 m³/h |
| 12 rpm | 590 m³/h | 568 m³/h | 547 m³/h | 511 m³/h |
| 14 rpm | 722 m³/h | 695 m³/h | 670 m³/h | 625 m³/h |
| 16 rpm | 852 m³/h | 820 m³/h | 791 m³/h | 738 m³/h |

The first and second preliminary database are then merged to produce table 1. For example, from table 3, at a pump speed of 5 rpm and a 1 m suction height the amount of air in cubic meters per hour required in the first loop in the coil pump to achieve a predetermined flowrate (and maximum head loss potential) is 262 m³/h. Referring to table 2, for a suction height of 1 m, 262 m³/h lies between 40% and 60% opening. The example tables are illustrative only and thus do not show the granularity of the databases to be used in practice, wherein percentage openings intervals will be in the region of 1%. The actual percentage opening for the corresponding 262 m³/h (at a pump speed of 5 rpm and a suction height of 1 m) gives a valve opening percentage of 56% (for a predetermined flowrate and with an air-water ratio of 1:1).

In practice, a desired flowrate is inputted into the system. The pump knows its own speed for which it runs at, and pressure sensors provide accurate readings of the suction height and lifting height. The lifting height is required to calculate the head loss required for determining the air-water ratio and pump speed. Thus, the program module accesses the corresponding opening versus pump speed and suction height database for the selected flowrate, and it retrieves the associated valve opening for the given pump speed and suction height. The control module then adjusts the valve opening to the retrieved value and the system will operate at the inputted, desired flowrate.

A first method of generating the flowrate and air-water ratio dependent databases of valve opening against pump speed and suction height is to use the air valve data sheet along with mathematical formulae as described below.

An air valve datasheet typically has a Cv value corresponding to different valve openings, for example 100%, 75%, 50%, 25%. For the example ball valve in FIG. 4a, this valve has a 60 degree opening and therefore is named a V-port as described above. The benefit of the V shape is a more linear opening curve, while the drawback is that you need a bigger valve to have the same maximum capacity.

Cv is calculated based on the formula:

$${C}_{v} = Q \sqrt{\frac{S G}{Δ P}}$$

Where Q is rate of flow (gallons per minute), SG is specific gravity of the fluid, and P is the pressure drop across the valve (psi).

The formula is modified to be applicable to air, and result in the below formula:

$${Q}_{a} = \frac{1}{60} \cdot 0.667 \cdot 4.17 \cdot {C}_{v} \cdot {p}_{1} \cdot \sqrt{\frac{{F}_{γ} \cdot {x}_{T}}{{T}_{a} + 273.15}}$$

Where Qa is the air flow rate (Nm³/min), p1 is the pressure, Fγ is specified heat ratio factor, and x_{T} is the pressure differential ratio factor (0.82).

A typical curve for different valves is shown in FIG. 4b which show a Kv curve. Kv can be multiplied by 1,156 to get the Cv value.

Once the calculations are in place, and the data sheet for the valve is provided, how much opening needed on the valve to reach a given air-water ratio in the pump can be calculated.

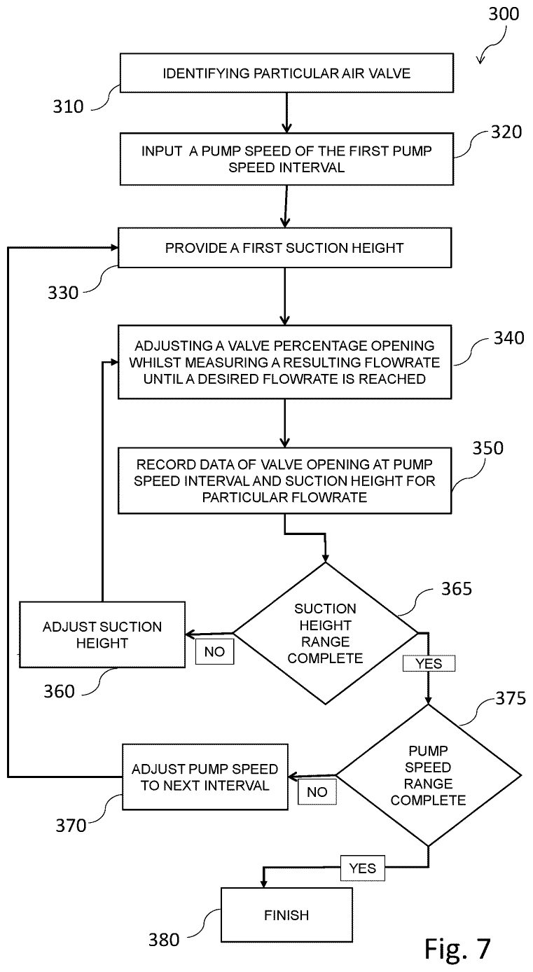

FIG. 7 is a flowchart of an alternative method 300 of creating flowrate and air-water ration dependent databases of valve opening against pump speed and suction height. Method 200 is an iterative measurement process. The method starts similarly to method 200 wherein a particular air valve is identified. At 320 a first pump speed is entered into the program for which the coil pump is to run at. At 330, a first suction height in the range is provided. Then, the coil pump is activated. Whilst the coil pump is running at the inputted first pump speed and suction height, the valve opening of the valve is adjusted through a range of opening states 340. Simultaneously to the adjustment of the valve opening, a resulting changing flowrate is measured until the predetermined flowrate is reached. At 350, the data computed from the first iteration is recorded, thus, the valve opening at the first pump speed and first suction height for a particular flow rate is recorded. At 365, it is determined whether the suction height range for the desired database is complete, if the range of suction heights is not completed, then the suction height is adapted to the next suction height in the suction height range. This may be achieved by raising or lowering an inlet pipe into a source container. When the next suction height in the range is set the method repeat steps 340 and 350. The method is repeated for all the suction heights in the desired range. Once it is determined that all of the suction heights in the range are complete, step 365, the method advances to step 375 wherein it is determined whether or not all the pump speed intervals are complete. If the pump speed interval is not complete, the method advances to step 370 wherein the pump speed is increased (or decreased) to the next pump speed interval in the desired pump speed range. The method as per steps 330 to 360 including cycling through all of the suction heights in the range is repeat for every pump speed interval in the pump speed range. Once it is determined that the full pump speed range has been completed the method completes 380. This is method is more time-consuming than method 200 but can be automatically implemented in software.

In a second example, in lieu of accessing pre-calculated databases, the relationship matrix for the specific flowrate and at least one air-water ratio is computationally generated in real time using the formulae above.

In a first example of method 200 (and method 300), the databases providing pump speeds and suction heights for various flowrates to provide valve opening values were generated, and thus are relevant only for, a 1:1 air-water ratio in the first loop of the coil pump of the system i.e., 50% air and 50% water in the first loop such that the air plug in the first loop Ap₁ is equal in volume to the water plug in the first loop Wp₁.

However, when the air-water ratio in the first loop is limited to 1:1, a maximum flowrate and a maximum lifting height is also limited. By adding more air, the pump can compress more air between the water plugs before the water begins to spill over into the previous loop. If the water spills over all the way back, the pump will stop pushing water through and the water will remain inside the pump. Therefore, the higher lifting capacity of the pump is due to the greater amount of air that can be compressed before the water overflows. On the other hand, if less air is added, there will be less capacity to compress air before the water starts to flow over. However, this will result in a higher water content in the pump, leading to a higher flowrate.

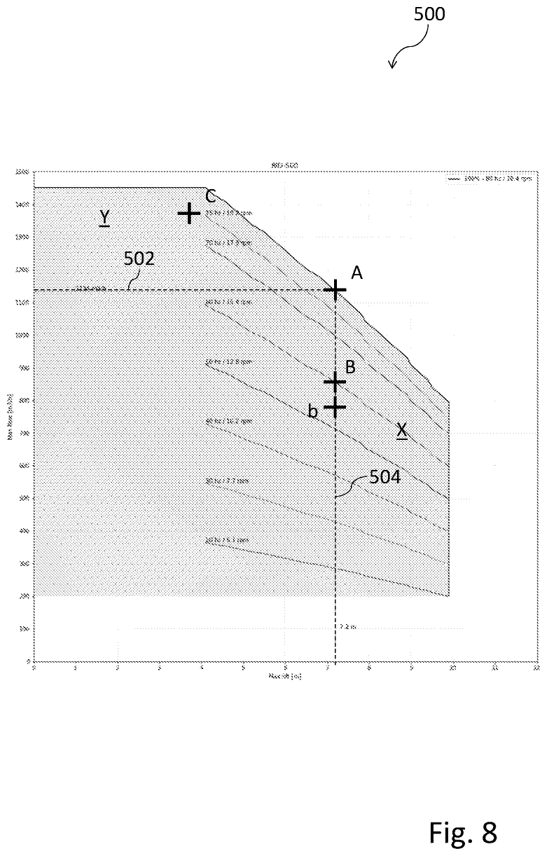

FIG. 8 shows a graph of maximum flowrate against maximum total pumping height of an example coil pump system according to the invention. The relationship between maximum flowrate and maximum total pumping height is confined to the area of the graph defined by lines 502 and 504 when the air-water ratio is 1:1. For example, at point A on the graph, the pump speed is 80 hz (20.4 rpm), the maximum flowrate is 1134 m³/h, and the maximum total pumping height is 7.2 m. Whereas, at point B on the graph, to achieve the same maximum total pumping height of 7.2 m (at an air-water ratio of 1:1), given a pump speed of 60 hz the flowrate maximum is reduced to approximately 860 m³/h. To achieve the same maximum total pumping height of 7.2 m (at an air-water ratio of 1:1), when the coil pump is running at a pump speed of 40 hz the flowrate maximum is approximately 580 m³/h. The maximum total pumping height can be distributed on the suction side and lifting side of the pump. For example, if the maximum total pumping height is 7.2 m, the pump can have 7.2 m on the suction side and 0 m on the lifting side, or vice-versa, or everything in between these limits.

A first approach is to try to maintain 50% air and 50% water giving a good compromise between flow rate, maximum pumping height and pump speed. For example, if a user enters 800 m³/h, point b corresponds to this flowrate, and lies between the 60 Hz line and the 50 Hz lines so the system needs around 55 Hertz (14 rpm). However, if the user then requests a maximum flowrate of 1000 m³/h, at this flowrate, a higher pump speed of around 18 rpm is required, yet in this region of the graph the lifting height may go above an achievable capacity. For example, assume a lifting height is 10 m, a flowrate of 1000 m³/h cannot be achieved at a 1:1 air-water ratio in the first loop. Since the pumping height is the job the pump has to do, this must be prioritized over flowrate and, thus, more air is added to the first loop to increase the maximum pumping height potential. The pump speed is not changed, but a water speed will be reduced since there will be a smaller quantity of water intake in each rotation.

It may be desirable to achieve a certain flowrate with a coil pump system of a certain total pumping height using a particular pump speed different to the pump speed given by the graph in FIG. 8. Thus, the method comprises adapting the air-water ratio to achieve the desired maximum flowrate, pump speed and maximum total pumping height. Introducing modification of the air-water ratio away from 1:1 gives rise to a coil pump system that can operate with settings depicted by the grey area beyond (above (area Y) and right (area X) of) the boundaries defined by lines 502 and 504. Varying the air-water ratio between 3:7 and 1:1 in the first loop of the coil pump, i.e., having a water plug having a larger volume than the corresponding air plug, allows for systems which can operate in the area Y section of the graph. Varying the air-water ratio between 1:1 and 17:3 in the first loop of the coil pump, i.e., having an air plug having a larger volume than the corresponding water plug in the first loop, allows for systems which can operate in the area X section of the graph. For example, at point C, a maximum flowrate 1400 m³ h is possible at a pump speed of approximately 19.2 rpm giving a maximum total pumping height of approximately 4 m, at an air-water ratio of approximately 7:13. The further above the boundary line 502, the larger the quantity of water to air, whereas the further to the right of boundary line 504, the larger the quantity of air to water.

Method 200 can be extended to incorporate systems operating with an air-water ratio deviating from 1:1 by having the series of database at different flowrates providing pumps speeds and suction height values that also depend on the air-water ratio. Thus, for every flowrate there comprises a series of air-water ratio dependent databases giving corresponding pump speed and suction heights.

The parameters of the flowrate, pump speed, pumping height, and air-water ratio are optimized based on a user's needs and/or preference. In a first example, the user enters the desired flowrate. The pumping height is known. The software then configures the other parameters (pump speed, air-water ratio) to meet user inputted optimization criteria. These optimization criteria may include minimizing/mitigating spilling, reducing the pump speed or maintaining the air-water ratio at 1:1 up to a predefined limit and then adjusted the air-water ratio to deviate away from 1:1 therewith.

Thus, the method of the invention further comprises configuring the coil pump as per the optimized settings i.e., configuring an opening of the air valve and configuring the pump speed. The opening of the air valve may be configured as described above.

Some particular example coil pump system optimisations are described below.

In a first example the coil pump system is configured to provide an optimised lifting capacity. The optimisation process is then as follows: run the coil pump at an air-water ratio of 1:1, allow maximum flowrate to be entered up to 1134 m³/h, and wherein the total pumping height of the coil pump system is greater than a capacity of the coil pump system at the provided settings, enable the system to configure to its “best lifting capacity” by modifying the air-water ratio above 1:1. For example an amount of air could be increased to 55% air in the first loop. If total pumping height goes beyond a higher capacity (for example 8m), an amount of air in the first loop can be increased to 60%. If total pumping height goes beyond a yet higher capacity (for example 8.8 m), an amount of air can be increased yet further to 65%. If total pumping height goes beyond a yet in further capacity (for example 9.7 m), the pump speed can be set to a maximum of 50 hz and an alarm may be sounded indicating that the total pumping height is exceeding the maximum capacity and the pump may fail to function.

In a second example the coil pump system is configured to provide an optimised maximum flowrate. For example, an amount of air may be decreased to 45% and maximum flow to be entered allowed up to 1400 m³/h. In other examples, if a flowrate of more than 1220 m³/h is entered, an amount of air in the first loop of the coil pump is allowed to decrease to 40%, if more than 1350 m³/h is entered, air may be decreased to 35%.

A user may enter into the system a desired flowrate, the pump system may then display the corresponding total pumping height capacity of the particular coil pump at that flowrate. If the coil pump is tasked with a job that exceeds its maximum capacity, the system will reconfigure the air valve such that more air is taken into the first coil. This will decrease the flowrate but will avoid that the pump stops functioning.

In a further particular example, the control mechanism for the pump is to maintain a certain flowrate, with the flowrate serving as the input. The pump strives to remain at a 50% air and 50% water composition for as long as possible, until the pumping height required exceeds the pump's capacity at that flowrate.

The method and coil pump system described herein has the capability of being optimised in a number of different ways depending on particular criteria and/or intended functioning of the coil pump system. In a yet further example, reduced drum rotation may be prioritised in order to save energy and/or limit noise. As an illustrative example, the pump may detect that it needs to pump water only 5 meters while the user wants a flowrate of 900 m³/h. In that case, the pump may be instructed to operate at 16.5 rpm with 50% air and 900 m³/h. However, given the criteria that energy efficiency is desired, the program module may identify that the pump speed can be adjusted to a lower speed, for example of 13 rpm, with the addition of less air in the first coil, and achieve the same flowrate and total pumping height, but more energy efficiently and possibly with better results for the fish.

The databases providing pump speed and suction height for a particular flowrate at a particular air-water ratio are generated based on a predetermined acceptable spilling factor. The spilling factor is the number of loops out of a total number of loops of the coil pump for which backflow (spilling) is accepted.

As a liquid plug progresses through a coil, it rotates relative to the external liquid surface as already mentioned. If this rotation is sufficiently great so that the trailing edge of the liquid plug reaches the crown of the pipe, then spilling will occur as the liquid spills over the crown of the loop and liquid flows from one plug back to the preceding plug. Spilling is assumed to take place when the horizontal liquid surface of the trailing edge of the liquid plug just reaches the lower wall of the crown of the pipe and thus will be dependent on water plug length as well as its rotation. With further reference to FIG. 2, loops 5 and 6 are at their limit before spilling occurs, above the height of the liquid in loop 5 and 6, liquid will flow from 6 back into 5 and from loop 5 back into loop 4.

It has been concluded through testing that a seven loops coil pump functions appropriately with spilling accepted up to 3 loops. Spilling above 50% of the loops of the coil pump can cause the coil pump to stop functioning if minor external factors change, such as delays in adjusting the air valve, change of pumping speed or change of pumping height. Furthermore, testing has shown that spilling on 3 loops provides a good compromise between fish welfare, energy efficiency and pumping capacity, and so this is the preferred setup in the system of the invention.

In most case, allowing spilling on 3 loops is acceptable for a well-functioning system. However, limiting the accepted number of loops that experience spilling below 3 loops may provide functional benefits. For example, to preserve an optimal water quality the number of loops experiencing spilling may be limited to 0 loops. This may protect weak fish. The relationships between the parameters of flowrate, total pumping height, pump speed, and air-water ratio change depending on the accepted spilling number entered into the equation. Thus, in order to accurately configure an opening of the air valve to take into consideration a specified acceptable spilling number, the plurality of databases further comprise a plurality of databases for various flowrates and various air-water ratios at several accepted spilling numbers. As an illustrative example, a user may want to optimise the system for fish welfare but need 8.5 m. If the pump cannot achieve this lifting height with 0 spilling, then the system will adjust to the next best acceptable number of spilling for the desired lifting height. For example, it may be that spilling on 2 loops can achieve 8.5 m total pumping height. Water quality still improved with spilling on 2 loops, than spilling on 3 and thus fish welfare is optimised for the given total pumping height.

In essence, the only active decision that the system will be required to make in any given situation is the amount of opening of the input air valve and pump speed, since the other parameters will be based on user input and optimisation criteria.

In order to convert the percentage for amount of opening into a unit that can be implemented by the control unit on the valve itself, the openings must be subjected to a digital to analogue conversion stage. Thus, the percentage openings are converted into Amperes. In an illustrative example, 0% opening is configured to be represented by 4 mA and 100% opening is configured to be represented by 20 mA, with increments in between.

To implement the method of the invention into each new pump system, a verification procedure may be performed. The verification procedure comprises selecting at least two control scenarios, each scenario being a particular running procedure of the machine having predetermined parameter settings. An air valve opening given by the corresponding database then sets an amount of opening on the air valve. The resulting flowrate is measured, for example by a flowmeter, and the error from the theoretical value observed. A flowmeter can be used for the verification procedure but is typically not involved during general operation of the coil pump.

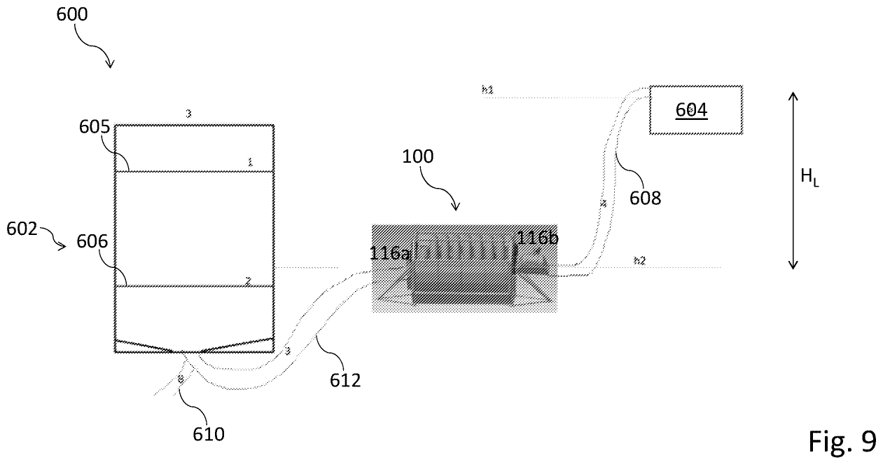

FIG. 9 show an arrangement 600 of a coil pump system using the coil pump 100 according to the invention. The system 600 has a container 602, the container at least partially filled with liquid, typically water and containing some quantity of fish. Line 605 demarks an example water level in the container when the container is in normal operation. Line 606 demarks an example water level in the container when coil pump 100 is capable of generating suction i.e., when the water level 606 is below a midpoint in the height of the container h2. The fish are transported from the container 602 into the coil pump 100 by inlet pipe 612, and are transported from the exit of the coil pump 100 to a grading (dewatering) unit 604 by outlet pipe 608. A further pipe 610 is attached to a lower end of the container 602 and is configured to drain a water level in the container to below the suction level h2 of the coil pump 100, i.e., from level 605 to level 606. Both pipes 610 and 612 have valves at their connections to the container 602 respectively and, thus, water flow out of the container and into the correct pipe, for drainage or pumping purposes can be controlled. The coil pump 100 has an inlet air valve 116a comprising an inlet pressure sensor (not shown) and an outlet air valve 116b having an outlet pressure sensor (not shown). Draining the container, may cause air pockets which may vary in size. The container 602 may need to be drained, for example to crowd the fish so that they are close enough to the inlet pipe 612 to be taken up by the inlet pipe 612. The air pockets may arise as small bubbles up to large pockets of air. These air pockets/bubbles can enter into the coil pump and undesirably alter the preset air-water ratio. This may lead to an undesired performance of the coil pump in the form of a reduced flowrate resulting from an increase in air in the coil pump 100.

An outlet of the coil pump 100 is at the center height h2. A top of the grading (dewatering) unit 604 it at a level h1. Thus, there is a height difference Δh between the pump outlet up to the grading unit 604, referred to herein as static height Δh. The static lifting height H_{L} can be measured as a pressure by the outlet pressure sensor. Additional resistance will also occur in the form of pipe friction from water flow. Therefore, a total pressure measured by the outlet pressure sensor is static height H_{L} in addition to a pipe resistance. When the water flow is reduced, the pipe resistance pressure drop will also be reduced. Unwanted air bubbles can then be detected by a resultant reduction in the total measured pressure by the outlet pressure sensor for a given constant pump speed. Since the presence of unwanted bubbles is indicative of an excess of air in the coil pump, a reduction in air taken in at the inlet is desired. Thus, to counteract the excess air, the opening of the air valve is reduced until the flowrate returns to a desired value, as indicated by the outlet pressure sensor. The container 602 may need to be almost completely drained through pipe 610 to empty fish from the container through pipe 612. The emptying the container of fish is a circumstance wherein significant air bubbles may arise and need to be counteracted. This method circumvents the need for a flowmeter connected to the pump when the coil pump system is in operation which is not desired since a flowmeter is typically expensive and the flowmeter may not function well when air pockets are present in the pipe.

With further reference to the system in FIG. 5b, the outlet pressure sensor 1040b is in data communication with the program module 1020. The program module 1020 receives information about the state of the total pressure in the coil pump 100 and uses it to compute if there are likely air bubbles in the coil pump 100. The program module 1020 then makes a corresponding adjustment to the control modules 1010a, 1010b and the inlet valve control module 1010a controls the inlet valve 116a to adjust the valve opening. By the same means, the system identifies that the readjustment of the inlet air valve 116a has brought the flowrate back up to the desired rate since the outlet pressure sensor 1040b will detect a pressure increase.

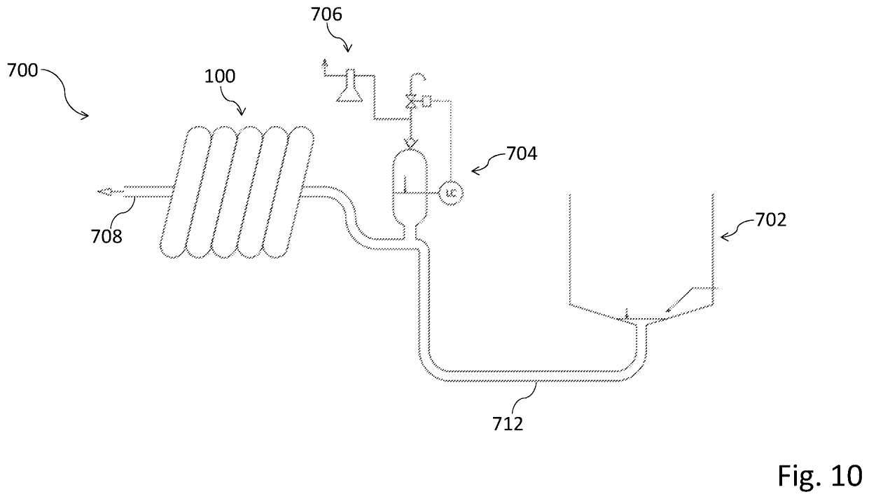

FIG. 10 show an alternative arrangement using the coil pump 100 according to the invention. The alternative arrangement is an alternative method of removing unwanted air from the coil pump 100. This arrangement involves using a vacuum to create a negative pressure environment that draws excess air out of an inlet pipe 712 before a fluid inside the inlet pipe reaches the coil pump 100. This process can be done by connecting a vacuum pump 704 to a port on the inlet pipe 712 and running it to evacuate the air.

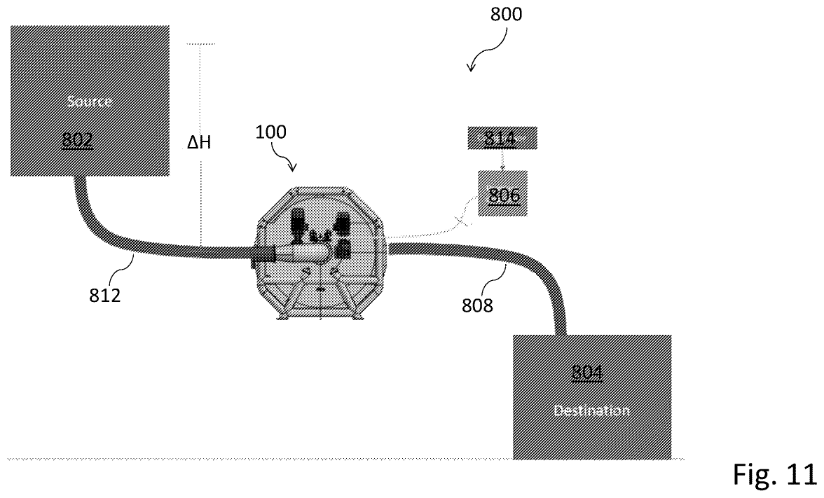

FIG. 11 shows an example arrangement of a coil pump system comprising the coil pump 100 according to the invention. The arrangement comprises a source tank 802 connected to the coil pump by an inlet pipe 812, a destination 804 connected to the coil pump 100 by an outlet pipe 808, a pressure chamber 806 is fluidly connected to an air valve of the coil pump 100, and a compressor 814 does work on the pressure chamber to compress air within the pressure chamber 806. A pressure sensor (not shown) measuring the air pressure in 806 is used as input to the control module 116a from FIG. 5b to further calculate the input air valve opening in 116a. The source is at a distance AH from a center of the coil pump 100. The arrangement 800 is used in cases where it is desired that the coil pump system supports a positive pressure at the inlet side of the pump, wherein the water level of the source tank 802 is above the centre of the coil pump.

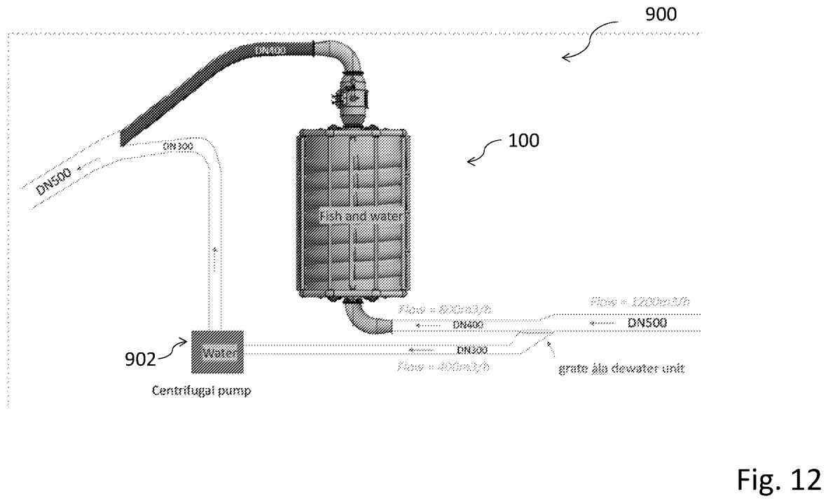

FIG. 12 shows another example arrangement 900 of a coil pump system comprising the coil pump 100 and comprising a centrifugal pump 902. The arrangement 900 is used in cases where it is desirable to increase a water speed and potentially the pumping height.

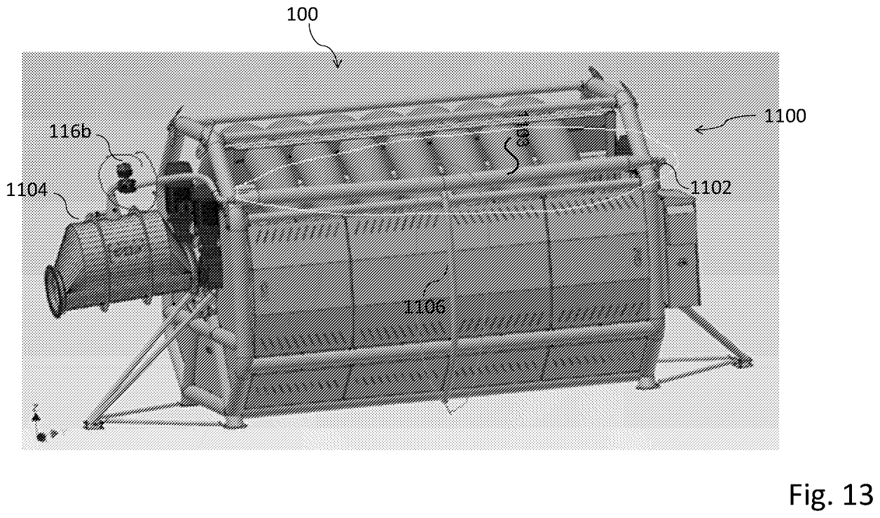

FIG. 13 shows the coil pump 100 comprising a noise cancelling unit 1100. Expelling air directly through the air valves (both on the inlet side 1102 and the outlet side 1104) can cause a lot of noise. This is because a significant amount of air is being passed through a relatively small valve opening. This problem is addressed by the noise cancelling unit 1100 wherein a pipe 1103 fluidly connects the outlet valve 116b and the inlet valve (not shown), such as outlet valve 116b and the inlet valve 116a shown in FIG. 9. During normal operation of a coil pump system, most air inputted into the coil pump will be removed. Thus, for the noise cancelling unit 1100, the air removed at the outlet is redirected back into the inlet air valve. Preferably, the pipe 1103 has a relatively large diameter, so that air exiting the outlet air valve 116b is slowed down. The pipe has a diameter in the range of 5 cm to 30 cm, more preferably three times the diameter of the air input valve.

The benefit of the noise cancelling unit 1100 is that in a steady state, the volume of air put into the pump will be equal to the air removed. Instead of a noisy air valve in, and a noisy air valve out, this configuration will circulate the air in a semi-closed environment which results in less noise. A change in air volume is achieved through a second pipe 1106 which has an open end at a bottom of the coil pump 100 in use. Another benefit of this configuration is that it may include a pressure sensor to be located within the noise cancelling unit 1100 suitable for measuring a change in the air going in and/or out of the coil pump 100 that can be further input to the program module 1020 in FIG. 5b.

Having described preferred examples of the invention it will be apparent to those skilled in the art that other embodiments incorporating the invention may be used. Features of the all the aspects and embodiments of the invention can be combined except where clearly incompatible. These and other examples of the invention illustrated above are intended by way of example only and the actual scope of the invention is to be determined from the appended claims.

1. A method for improved functioning of a coil pump system, comprising configuring an inlet air valve, wherein said configuring of said inlet air valve comprises:
a) identifying a particular air valve of said coil pump system out of a predetermined number of potential air valves;
b) providing a pump speed for a coil pump in said coil pump system;
c) providing a suction height of said coil pump system; and
d) retrieving an amount of opening of said identified air valve of said coil pump system for said associated provided pump speed and suction height to achieve a desired flowrate through said coil pump system
wherein step d) further comprises:
using at least one valve opening relationship matrix for a specific flow rate and at a selected predetermined air-water ratio in a predetermined loop of said coil pump;
wherein said at least one valve opening relationship matrix comprises a series of valve openings against corresponding pump speeds and suction heights; and
retrieving from said valve opening relationship matrix a valve opening corresponding to said provided pump speed and suction height at said desired flowrate and said air-water ratio.

2. The method of claim 1, wherein said at least one relationship matrix for said specific flowrate and at least one air-water ratio is computationally generated in real time.

3. The method of claim 1, wherein using said at least one valve opening relationship matrix comprises:
accessing a series of pre-calculated databases of valve openings against corresponding pump speeds and suction heights for a series of flowrates and at least one air-water ratio stored in an accessible computer memory; and
selecting a specific valve opening database for said specific flow rate and at a selected predetermined air-water ratio out of said series of pre-calculated databases; and
using said selected valve opening database to retrieve a valve opening corresponding to said provided pump speed and said suction height at said desired flowrate and said air-water ratio.

4. The method of claim 1, wherein step c) comprises measuring said suction height of said coil pump by an inlet pressure sensor at an inlet end of said coil pump.

5. The method of claim 1, wherein step c) comprises manually inputting said suction height.

6. The method of claim 1, further comprising a verification step comprising:
running said coil pump at a selection of predetermined pump speeds, air-water ratio and suction heights;
adjusting a valve opening whilst measuring a resulting flowrate; and
comparing said measured resulting flowrates at said selected pump speeds, air-water ratio and suction heights to corresponding flowrates provided in a valve opening database.

7. The method of claim 1, wherein said predetermined air-water ratio in a predetermined loop of said coil pump is 1:1.

8. The method of claim 1, further comprising extending a functioning capability of said coil pump system such that a greater range of pump speed, flowrate and pumping height combinations become available by deviating said air-water ratio in said predetermined loop of said coil pump away from a 1:1 ratio to achieve a particular functioning of said coil pump.

9. The method of claim 8, wherein said valve opening relationship matrix has a further parameter dependency, said parameter dependency being a plurality of air-water ratios.

10. The method of claim 8, wherein said series of available valve opening databases for a plurality of flowrates and at least one air-water ratio, comprises a series of valve opening databases for a plurality of flowrates and a plurality of air-water ratios.

11. The method of claim 6, wherein said plurality of air-water ratios range from 3:7 to 7:3.

12. The method of claim 8, wherein said particular functioning of said coil pump system comprises:
an increased pumping height of said coil pump system; or
an increased flowrate
at a constant pump speed.

13. The method of claim 8, wherein, within certain predetermined parameters, said flowrate, pump speed, pumping height, and air-water ratio are configured to achieve a maximum energy efficiency.

14. The method of claim 1, wherein said method further comprises compensating for unintentional air in said coil pump system by:
identifying a change in pressure by an inlet pressure sensor when said pump is operating at a constant pump speed and with a static suction height on an inlet side of said coil pump; and/or
identifying a change in pressure by an outlet pressure sensor when said pump is operating at a constant pump speed and a static lifting height on an outlet side of said coil pump,
wherein a reduced pressure indicates presence of unintentional air; and
adjusting said inlet air valve opening to reduce air intake through said valve to compensate for presence of said unintentional air.

15. A coil pump system comprising:
a coil pump comprising:
a tubular rotor with a helical channel with at least two windings;
an intake end comprising:
an inlet air valve, said valve comprising an inlet control module; and
an inlet pressure sensor; and
an outlet end comprising:
an outlet pressure sensor; and
an outlet air valve; and
a program module, said program module in data communication with said inlet control module, said inlet pressure sensor, and said outlet pressure sensor;
wherein said system is configured to adjust an opening of the inlet air valve, by accessing a relationship matrix of flowrate, air-water ratio and suction height, to achieve a predetermined flowrate.

16. The coil pump system of claim 15, further comprising a noise cancelling unit comprising:
a pipe fluidly connected at a first end to said inlet air valve, at a second end to said outlet air valve;
said pipe configured to redirect air released through said outlet air valve into said coil pump inlet via said inlet air valve.

17. The coil pump system of claim 16, wherein the pipe has a diameter at least two times the diameter of said inlet air valve and at most 5 times the diameter of said inlet air valve.

18. (canceled)

19. The coil pump system of claim 15, further comprising:
an inlet pipe connected at a first end to said intake end of said coil pump;
an outlet pipe connected at a first end to said outlet end of said coil pump;
a container for fish connected to a second end of the inlet pipe; and
a grading unit, dewatering unit, or container connected to a second end of said outlet pipe;
wherein, in use, said system is configured such that a liquid level in said container for fish is below a center height of said coil pump.

20. The coil pump system of claim 15, wherein:
said inlet pressure sensor is further configured to measure a change in pressure at said inlet end when said coil pump is running at a constant pump speed and at a static suction height; and/or
said outlet pressure sensor is further configured to measure a change in pressure at the outlet end when said coil pump is running at a constant pump speed and at a static lifting height;
to identify presence of unintentional air.

21. The coil pump system of claim 15, further comprising a fish counter, said fish counter located at said inlet pipe, or at said outlet pipe or at an outlet of said grading unit, said fish counter in communication with said program module and configured to provide feedback modify said flowrate such that fish traveling through said pump system are crowded within a predetermined density range.

22. (canceled)

23. A computer readable medium with instructions that, when executed on a processor, perform the steps of claim 1.

24. The coil pump system of claim 15, where in the program module comprises the computer readable medium of claim 23.
